(19) United States
(12) Patent Application Publication
(10) Pub. No.: US 2021/0235163 A1
(43) Pub. Date: Jul. 29, 2021

(54) VALIDATING INTERACTION WITH INTERACTIVE SECONDARY CONTENT

(71) Applicant: Ad Revenue Solutions Inc, Los Angeles, CA (US)

(72) Inventor: Alan Hirsch, Los Angeles, CA (US)

(21) Appl. No.: 17/157,610

(22) Filed: Jan. 25, 2021

Related U.S. Application Data
(60) Provisional application No. 62/965,989, filed on Jan. 26, 2020.

(51) Int. Cl. H04N 21/475; H04N 21/81; H04N 21/8545

(52) U.S. Cl. CPC H04N 21/4758; H04N 21/8545; H04N 21/812

(57) ABSTRACT

A server computer may be configured to receive a request for secondary content to provide to an electronic device based on a request for primary content. The server computer may further be configured to select secondary content including a set of non-interactive elements and a set of one or more interactive elements to provide to the electronic device. The set of one or more interactive elements may be configured to receive user interaction. The server computer may also be configured to provide, to the electronic device, (1) data identifying the selected secondary data to the electronic device and (2) data regarding a first (and second) set of one or more interactions with the set of interactive elements that will (and will not) trigger skipping the remainder of the presentation of the secondary content.

### CROSS REFERENCE TO RELATED APPLICATION(S)

This application claims the benefit of U.S. Provisional Application Ser. No. 62/965,989, entitled “Method and Apparatus to Provide Content to a Network User” and filed on Jan. 26, 2020, which is expressly incorporated by reference herein in its entirety.

### BACKGROUND

### Technical Field

The present disclosure relates generally to the provision of interactive secondary content, and more particularly, to serving interactive secondary content through an interface with interactive elements, tracking interactions, and providing analysis of the tracked interactions.

### INTRODUCTION

Network users who seek to view primary content over a network are often forced to watch secondary content, such as advertising, in order to view the primary content. Secondary content may also be inserted one or more times during the playing of the primary content. Secondary content such as advertising is provided over a network such as the Internet and in some cases can be skipped. When the secondary content is skippable, a network user may not engage with the secondary content negating the purpose of presenting the secondary content (e.g., the advertisement).

### SUMMARY

The following presents a simplified summary of one or more aspects in order to provide a basic understanding of such aspects. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that is presented later.

Skippable secondary content (e.g., advertisements) do not force a viewer to engage with, or pay any attention to, the secondary content. From an advertiser's perspective there would be a benefit to encouraging a user to pay attention to, and engage with, secondary content. As users are often presented secondary content prior to, or in the middle of, consuming primary content, presenting them with an opportunity to get back to the primary content more quickly by engaging with secondary content presented to them may result in increased user engagement.

In an aspect of the disclosure, a method, a computer-readable medium, and an apparatus are provided. The apparatus may be a server computer of a secondary content provider. The server computer may be configured to receive a request for secondary content to provide to an electronic device (e.g., a personal computer, laptop, wireless device, mobile phone, etc.), based on a request by the electronic device for primary content. The server computer may further be configured to select secondary content to provide to the electronic device, the secondary content including a set of non-interactive elements and a set of one or more interactive elements. The set of one or more interactive elements may be configured to receive user interaction and respond with one of (1) skipping a remainder of a presentation of the selected secondary content and (2) indicating that the interaction will not cause the remainder of the presentation of the selected secondary content to be skipped. The server computer may also be configured to provide, to the electronic device, (1) data identifying the selected secondary data to the electronic device and (2) data regarding a first set of one or more interactions with the set of interactive elements that will trigger skipping the remainder of the presentation of the secondary content and a second set of one or more interactions with the set of interactive elements that will not trigger skipping the remainder of the presentation of the secondary content.

The set of identified actions include, in some aspects, (1) a first identified action for at least a first interaction with a first interactive element in the set of interactive elements, the first identified action including displaying a first indication for further interaction with the set of interactive elements, and (2) a second identified action for at least a second interaction with a second interactive element in the set of interactive elements, the second identified action including skipping to the primary content requested by the electronic device. In some aspects, the first and second interactive elements are a same interactive element (e.g., a text entry input element) and the first and second identified actions are taken based on whether the interaction (e.g., text input) is considered a “correct” response/interaction (e.g., a correct answer to a question posed in a non-interactive secondary content element). In some aspects, the secondary content includes a non-interactive video advertisement, a non-interactive question overlay (or display element), and a set of one or more interactive answer elements (e.g., multiple selectable answer elements, or a single text entry answer element).

The server computer configured to identify the particular secondary content to provide to the electronic device, in some aspects, is further configured to identify a first non-interactive video advertisement element from a plurality of candidate non-interactive video advertisement elements (e.g., a number of candidate advertisements for a first product campaign). The server computer may further be configured to identify a second non-interactive question overlay element from a plurality of non-interactive question overlay elements associated with the first non-interactive video advertisement (e.g., to identify a question from a set of questions related to the content of a selected video advertisement). The server computer may also be configured to identify, from multiple selectable answer elements associated with the identified second non-interactive question overlay element, a set of at least (1) a first selectable answer element comprising an incorrect answer and (2) a second selectable answer element comprising a correct answer. In some aspects, the server computer may be configured to identify a correct input to a text input answer element based on the identified second non-interactive question overlay element for a secondary content client on the electronic device to compare to a provided input.

A server computer, in some aspects, is a tracking server computer that collects data regarding interactions with secondary content at multiple electronic devices. The server computer may be configured to receive data regarding secondary content provided to each of multiple electronic devices based on requests by the multiple electronic devices for primary content. In some aspects, the secondary content provided to each of the multiple electronic devices includes a set of non-interactive elements and a set of one or more interactive elements, the set of interactive elements includes (1) at least one interactive element for which a first interaction results in displaying a first indication for further interaction with the set of interactive elements, and (2) at least one interactive element for which a second interaction results in skipping to the primary content requested by the electronic device. In some aspects, the first and second interactions are with a same interactive element (e.g., a text entry input element) and the first and second identified actions are taken based on whether the interaction (e.g., text input) is considered a “correct” response/interaction (e.g., a correct answer to a question posed in a non-interactive secondary content element). In some aspects, the secondary content includes a non-interactive video advertisement, a non-interactive question overlay (or display element), and a set of one or more interactive answer elements (e.g., multiple selectable answer elements, or a single text entry answer element).

The server computer may further be configured to receive, from each of the multiple electronic devices, information regarding at least a set of interactions at the electronic device with the interactive elements provided to the electronic device based on the request by the electronic device for primary content. The server computer may also be configured to provide, to a particular electronic device based on a request for primary content, secondary content based on the received data regarding the secondary content provided to each of the multiple electronic devices and the received information regarding the at least a set of interactions at the electronic device with the interactive elements.

To the accomplishment of the foregoing and related ends, the one or more aspects comprise the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

FIG. 1 is a diagram illustrating an example of a secondary content provider in communication with an electronic device and a content delivery network (CDN).

FIG. 2 is a call flow diagram illustrating communications between a secondary content provider, an electronic device, and a CDN.

FIG. 3 is a diagram illustrating an example of secondary content provided to a client device being composed to overlay primary content.

FIG. 4 is a diagram illustrating an example of a set of interactions with secondary content interactive elements that result in different actions being taken by a secondary content player.

FIG. 5 is a state diagram related to the transitions illustrated in FIG. 4.

FIG. 6 is a diagram illustrating an example of elements of a secondary content server.

FIG. 7 is a diagram illustrating example data that may be stored by a secondary content server.

FIG. 8 is a diagram illustrating an example of elements of a secondary content tracking server.

FIG. 9 is a diagram illustrating example data that may be received and stored by a secondary content tracking server.

FIG. 10 is a flowchart of a method of providing secondary content.

FIG. 11 is a flowchart of a method of tracking provided secondary content.

FIG. 12 illustrates a computer environment upon which example implementations may be applied.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known structures and components are shown in block diagram form in order to avoid obscuring such concepts.

Some aspects may improve on previous secondary content provision technology that does not determine whether an input or interaction is correct or incorrect and perform different actions based on the results of the determination. The provision of secondary content, in some aspects, is for the purpose to make users aware of, or familiar with, the content of the secondary content but if any interaction functions to skip the secondary content there is no need to attend to the content of the secondary content. Accordingly, presenting a question with interactive answer element(s) related to the content of the secondary content as discussed below engages the user in a novel way. Additionally, presenting a question with interactive answer element(s) related to the content of the secondary content as discussed below allows for the collection of data and analysis of that data to provide information and insight that was not available in systems not presenting a question along with interactive answer element(s).

Several aspects of systems for providing secondary content will now be presented with reference to various apparatus and methods. These apparatus and methods will be described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors. Examples of processors include microprocessors, microcontrollers, graphics processing units (GPUs), central processing units (CPUs), application processors, reduced instruction set computing (RISC) processors, systems on a chip (SoC), field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software shall be construed broadly to mean instructions, instruction sets, code, code segments, program code, programs, subprograms, software components, applications, software applications, software packages, routines, subroutines, objects, executables, threads of execution, procedures, functions, etc., whether referred to as software, firmware, middleware, microcode, hardware description language, or otherwise.

Accordingly, in one or more example embodiments, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, and not limitation, such computer-readable media can comprise a random-access memory (RAM), a read-only memory (ROM), an electrically erasable programmable ROM (EEPROM), optical disk storage, magnetic disk storage, other magnetic storage devices, combinations of the aforementioned types of computer-readable media, or any other medium that can be used to store computer executable code in the form of instructions or data structures that can be accessed by a computer.

Some aspects involve methods to provide novel interactive secondary content elements (e.g., interactive selectable answers to a question that include at least one incorrect answer and at least on correct answer) and collect novel data regarding the efficacy of an advertisement provided as secondary content. The novel secondary content provision and data collection may allow determinations of a level of engagement with the secondary content and a level of knowledge of an advertised product based on, for example, how many wrong answers are received before a correct answer or how much time elapses before a correct answer is selected. This improves upon selectable elements that represent survey questions, skip buttons, or choices for additional content to enable skipping which do not provide any information regarding user engagement.

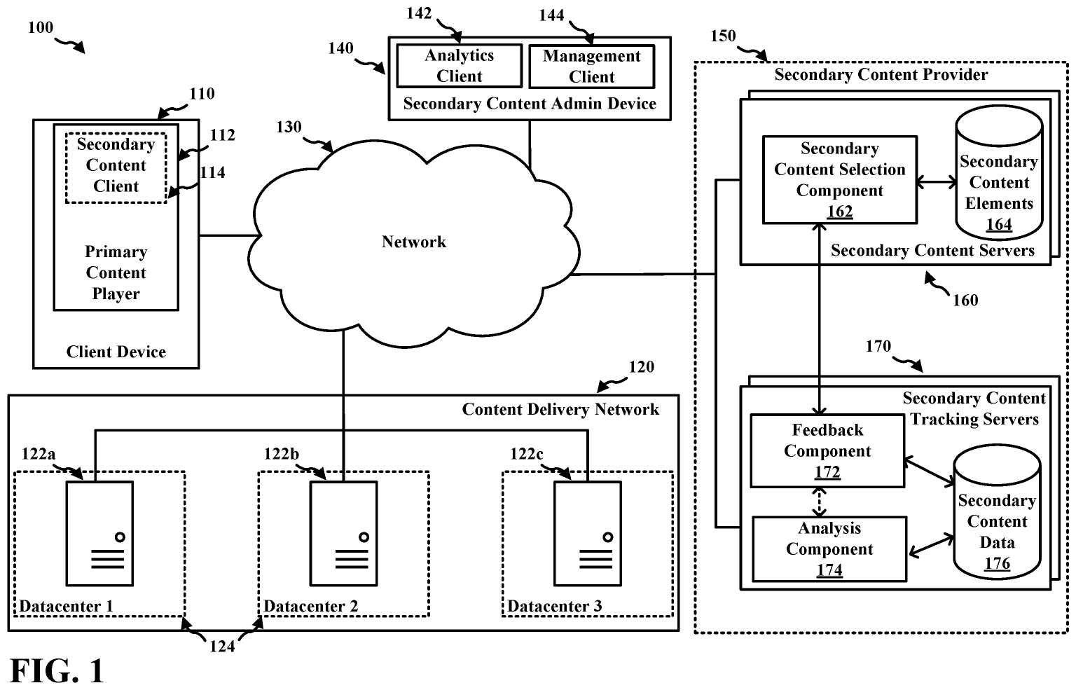

FIG. 1 is a diagram 100 illustrating an example of a secondary content provider 150 in communication with an electronic device (client device 110) and a CDN 120. FIG. 1 illustrates that client device 110 may include a primary content player 112 (provided by a primary content provider such as a streaming or video provider, or in a browser) that in turn may include a secondary content client 114 for requesting and providing secondary content. The client device 110 may request primary content from a primary content provider through network 130. The primary content provider may in turn request secondary content to present before presenting the primary content or to interrupt the primary content. For example, a client device 110 requesting primary video content from a website may be provided secondary content (e.g., an advertisement) before proceeding to the requested primary content or at a predetermined time during the presentation of the primary content.

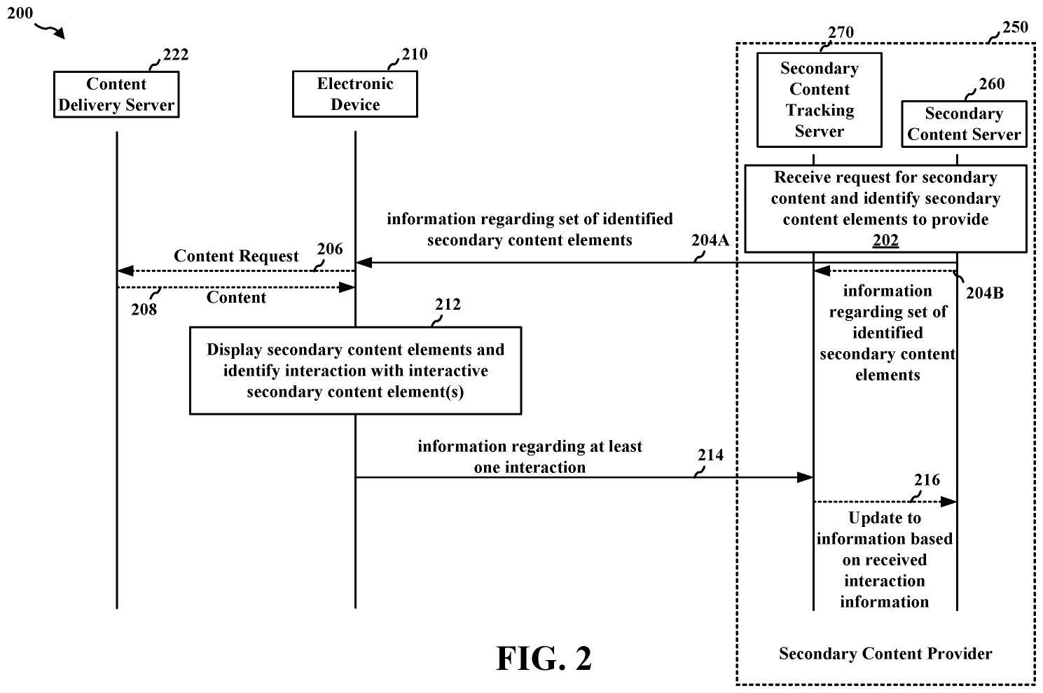

The primary content provider may use the secondary content client 114 associated with the primary content player 112 to request the secondary content. The secondary content client 114 may communicate with secondary content provider 150 and more specifically with one of secondary content servers 160. The secondary content servers 160 (and secondary content tracking servers 170) may be located in different geographical locations, or different datacenters for improved latency or redundancy. The secondary content server 160 may identify secondary content to provide to the secondary content client 114 as will be discussed further in relation to FIGS. 2, 3, 6, 7, and 10. The identification may include identifying (1) a campaign from multiple candidate campaigns, (2) a particular advertisement (e.g., non-interactive video secondary content) of the identified campaign, (3) a question associated with the campaign or particular advertisement (e.g., “How much can you save with [the advertised service or product]?”, “What do people use [the advertised service or product] for?”, etc.), and (4) set of interactive elements for receiving user input (e.g., a text input element, or a set of two or more selectable answers). For example, a secondary content server 160 may identify a campaign for a vendor that has four different candidate advertisements highlighting four different aspects of their service. The secondary content server 160 may identify a particular advertisement highlighting download speed, and then identify one of three questions relating to download speed and select four of seven possible answers (including at least one correct answer and at least one incorrect answer) to provide to a secondary content client.

The campaigns, the associated advertisements, the questions, and the interactive answer elements, in some aspects, are managed by a campaign administrator through a secondary content administrator device 140 which may be a computer executing a secondary content administration software. The secondary content administrator device 140 may include a management client 144 that interacts primarily with the secondary content server 160 to control the content of a campaign (e.g., the advertisement videos, the questions, and the answers) and the layout of the elements. The secondary content administrator device 140 may include an analytics client 142 that interacts primarily with the secondary content tracking server 170 to request data and analytics from the secondary content tracking server 170 to determine, for example, the efficacy of certain advertisements, questions, or interactive elements.

In some aspects, the secondary content server 160 provides an identifier for non-interactive content (e.g., a universal resource locator (URL) or other pointer) to a CDN 120 that may be configured to have content delivery servers 122a-c in multiple datacenters 124 in multiple different geographic locations to improve latency and provide redundancy. The secondary content client 114 then uses the pointer or URL to retrieve the indicated video advertisement from the CDN 120. The question and interactive element data may be less resource intensive and may be sent directly from the secondary content server. The client device 110 (or secondary content client 114) may then compose the secondary content elements for display over the primary content until the end of the advertisement or an interaction leads to skipping the remainder of the secondary content.

After the secondary content has completed playing (either based on reaching the end of the secondary content video element, or based on an interaction leading to skipping the rest of the secondary video content), the secondary content client, in some aspects, sends information regarding the secondary information received and the interactions with the received secondary content. For example, a secondary content client 114 may report to secondary content tracking server 170, information regarding (1) a campaign identifier, (2) an advertisement identifier, (3) a question identifier, (4) a set of interactive element (e.g., answer) identifiers, (5) a set of interactions (an ordered set of selected answers), (6) a timing of the interactions, (7) a user identifier (ID) associated with the user of the client device 110 (e.g., based on being logged into an associated account), (8) a browser identity, (9) an application identity, (10) the settings for intervals before accepting further input/interaction, (11) and an interaction ID (e.g., an ID that may be used to correlate data in different databases).

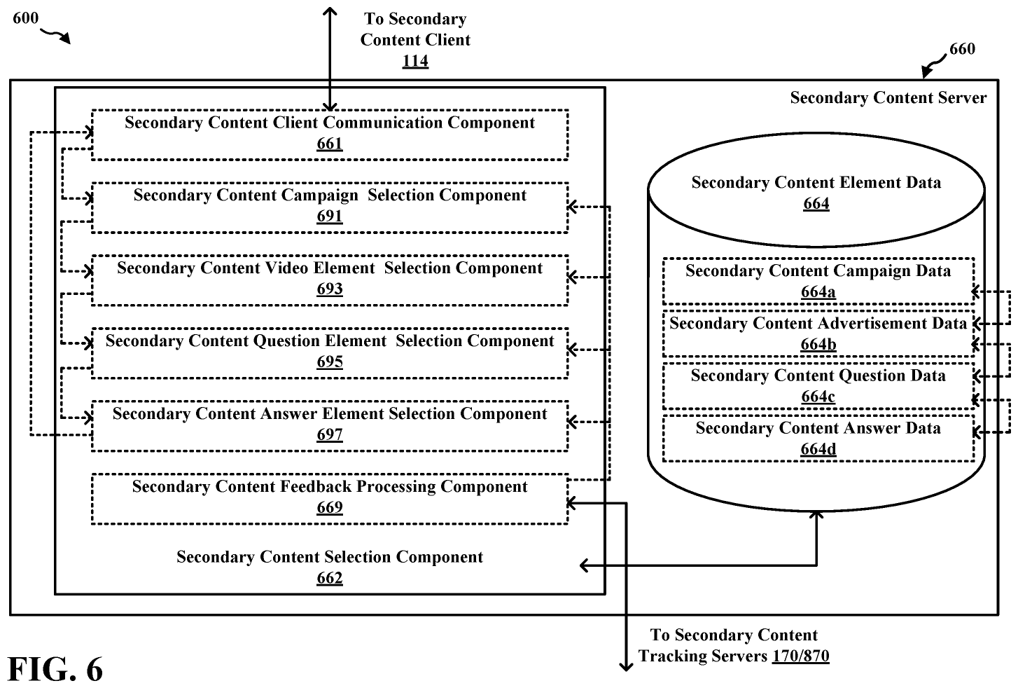

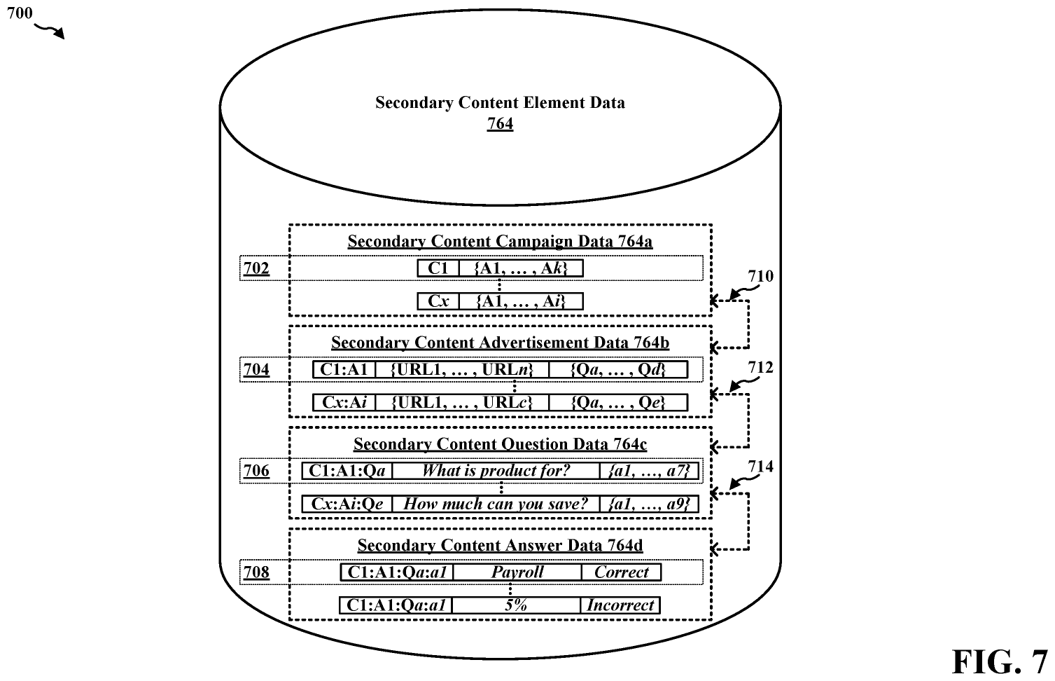

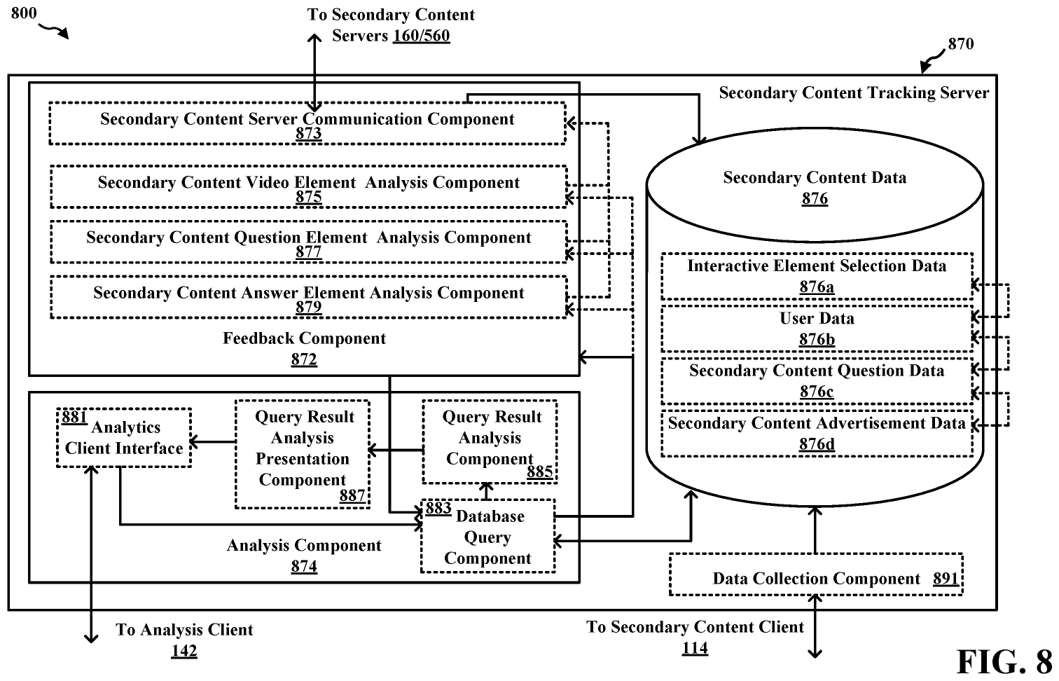

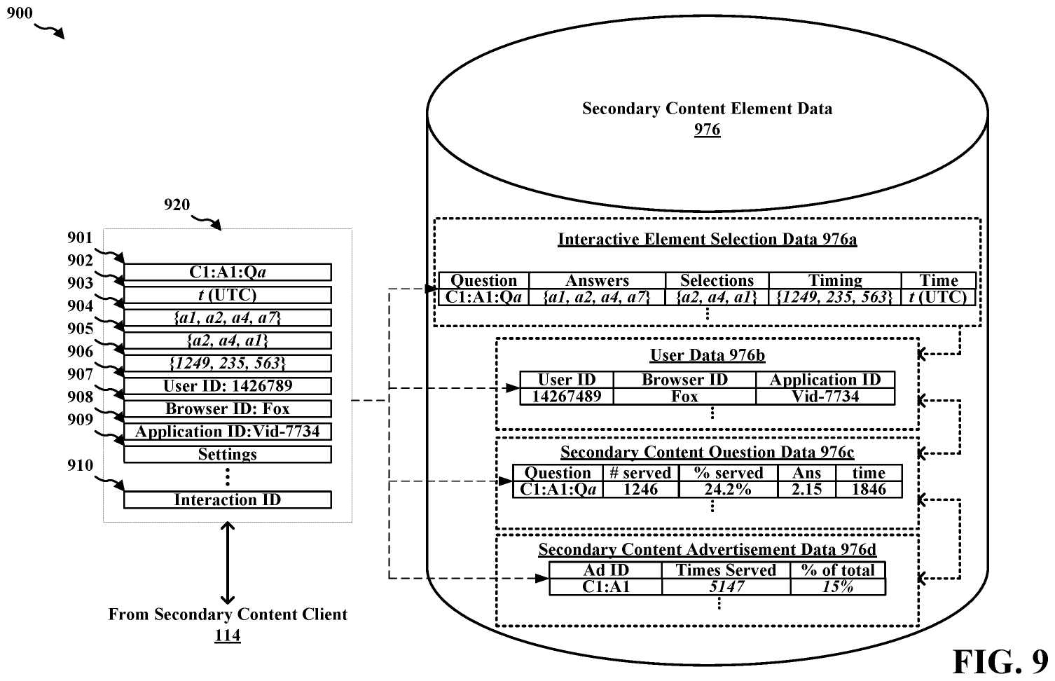

As illustrated, secondary content provider 150 includes a set of secondary content servers 160 and a separate set of secondary content tracking servers 170. However, these may be a same server or be executing on a same set of physical devices. Secondary content selection component 162 and secondary content element database 164 of secondary content server 160 are discussed in more detail in relation to FIGS. 6 and 7. Feedback component 172, analysis component 174, and secondary content data storage 176 of secondary content tracking server 170 are discussed in more detail in relation to FIGS. 8 and 9.

FIG. 2 is a call flow diagram 200 illustrating communications between a secondary content provider 250, an electronic device 210, and a content delivery server 222. Optional elements are indicated by dotted lines. In some aspects, secondary content provider 250, an electronic device 210, and a content delivery server 222 may correspond to secondary content provider 150, the client device 110, and one of content delivery servers 122a-c of a CDN 120. The secondary content provider 250 may receive, at 202, a request for secondary content and identify secondary content elements to provide in response. The request received at 202 may include information regarding the user (e.g., a user ID for a user that has an account, such a rewards account, with the secondary content provider), information regarding the primary content (a URL or other identifier), an application playing (e.g., displaying or presenting) the primary content, an application playing (e.g., displaying or presenting) the secondary content, or any other relevant data the secondary client on the electronic device 210 is configured to collect and send with a request by the secondary content provider. In some aspects, the request is sent as a first communication with the additional information being provided in a separate (asynchronous) communication to not delay the provision of the secondary content. The secondary content provider 250 may receive the request from a secondary content client (e.g. client 114 of FIG. 1) or from a primary content server based on a video start, a video end, or a video reaching a certain point in time.

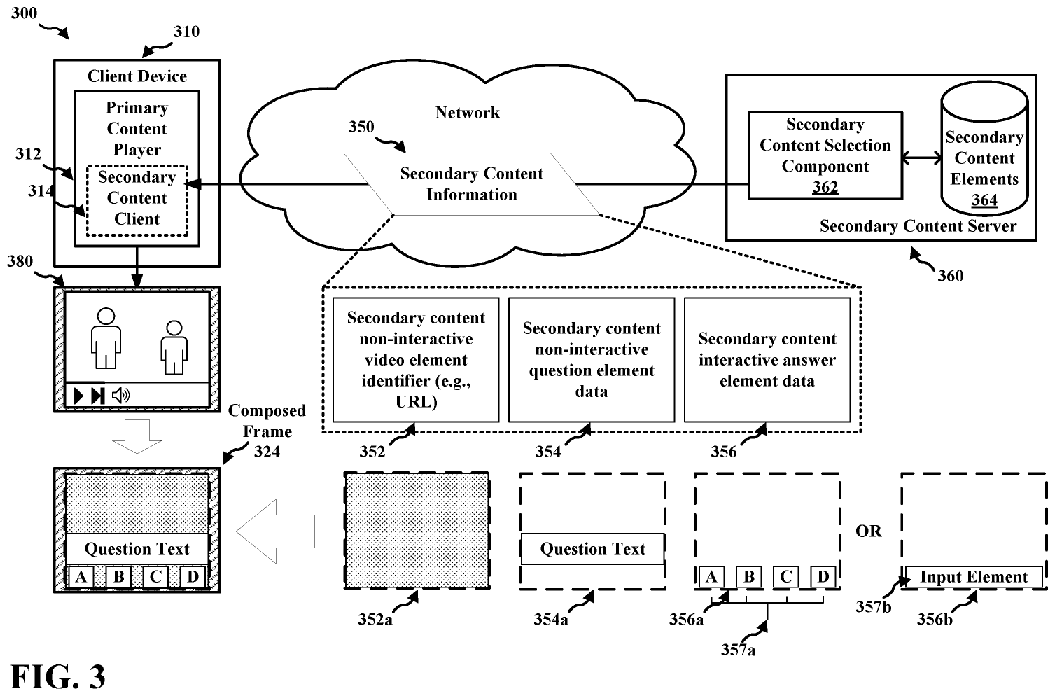

As discussed in relation to FIG. 1 above, and as will be discussed in relation to FIGS. 3, 6, 7, and 10 below, identifying the secondary content may be performed by a secondary content server (e.g., server 160 of FIG. 1) and may include identifying (1) a campaign from multiple candidate campaigns, (2) a particular advertisement (e.g., non-interactive video secondary content) of the identified campaign, (3) a question associated with the campaign or particular advertisement (e.g., “How much can you save with [the advertised service or product]?”, “What do people use [the advertised service or product] for?”, etc.), and (4) set of interactive elements for receiving user input (e.g., a text input element, or a set of two or more selectable answers). The identification may be based on the additional information provided along with the request. For example, a user ID (e.g., provided in metadata of the request) may be used to identify characteristics of the user such as gender, age group, approximate income level, location, etc. that are used in identifying a campaign, advertisement, question, and set of interactive answer elements that is targeted to users having at least one characteristic of the user (e.g., age group, location, etc.). For example, an administrator of a campaign for a restaurant in Los Angeles would not want to pay for ads presented to users distant from Los Angeles (e.g., in northern California, in another state, in another region of the country (north-east), etc.) and would only want the ads for that campaign to be provided to users identified as being located in the target area.

The secondary content provider 250 may send information 204A regarding the set of identified secondary content elements to the electronic device 210 (or a secondary content player/client, such as secondary content client 114 of FIG. 1, executing on the electronic device). The information 204A may include a pointer (e.g., a link or URL) to identified video secondary content hosted by a CDN, a question element ID (or question secondary content), a set of one or more interactive answer elements (e.g., a text input field, or a set of two or more selectable answer elements) along with an indication of a “correct” interaction (e.g., a correct text input or a selection of a subset of correct selectable answer elements), a time associated with the secondary content request (e.g., a universal coordinated time (UTC) expressed in seconds elapsed since midnight universal time (UT) on Jan. 1, 1970), and an identifier for the content served. Additionally, or alternatively, the information 204A may include an indication of incorrect input or subset of selectable answer elements, or additional interactive secondary content elements for learning more about the subject of the video secondary content (e.g., a link to a website for an advertised product). The information 204A may also include (1) information (e.g., a URL, an internet protocol (IP), and/or a media access control (MAC) address) for a secondary content tracking server to which to send feedback and (2) information regarding a feedback format either of which may alternatively be specified in the information 204A or pre-configured in a secondary content client (client 114 of FIG. 1). As for the video secondary content, in some aspects, the information regarding the question element and/or the interactive answer element(s) may include pointers to question content and/or interactive answer content for the electronic device 210 (or a secondary content client 114 of FIG. 1 or secondary content player) to retrieve (e.g., from a same or different content delivery server 222 or CDN or from a local storage storing common question and/or interactive answer elements).

The secondary content provider 250 may also provide information 204B regarding the identified secondary content from a secondary content server 260 to a secondary content tracking server 270. The secondary content tracking server 270 may update data stored by the secondary content tracking server 270 based on information 204B. For example, secondary content tracking server 270 may create a set of one or more database entries for the request in one or more tables or datasets (e.g., a user dataset, an advertisement dataset, a question dataset, and an interaction dataset) based on the information 204B. The information 204B may also be used to increment a value for a number of times a particular campaign, advertisement, question, and/or answer has been identified/provided to an electronic device 210 (e.g. to a user of the electronic device).

If the video secondary content was not provided by the secondary content provider, the electronic device 210 may then send a request 206 for video secondary content identified in information 204A to content delivery server 222. The request may include a URL or other pointer in information 204A. The content delivery server 222 may then identify the requested content and provide the video secondary content 208 to electronic device 210 (or secondary content client or player, such as client 114 of FIG. 1). The electronic device 210 may then display 212 the secondary content (e.g., the video secondary content, the question element, and the interactive answer element(s)) and monitor for user interactions such as entering text into a text input interactive answer element or the selection of a selectable answer element(s). The secondary content elements may be presented/displayed in stages, with a video secondary content being provided/displayed first, a question element being displayed next as an overlay on the video secondary content, and finally displaying the interactive answer element(s) as an additional overlay element of a second media player associated with the secondary content client. The timing can be adjusted by a campaign administrator (e.g., through management client 144 of FIG. 1) or can be randomized to determine an optimal time based on analysis performed at the secondary tracking server 270 (or 170/770 of FIGS. 1 and 7). The delay between presenting a question and answer may be used to focus the user's attention on the content of the advertisement to answer the question without attending to the advertisement only for key words presented in the interactive answer element(s). Additional elements of the presentation of the secondary content, such as a timer, a pause button, a volume control, etc. may also be presented by a secondary content media player associated with electronic device 210, but in some aspects such elements will not need to be provided by the secondary content provider 250 for each request.

The electronic device 210 may identify interactions with the secondary content. The identified interactions may include the order of a selection of a set of selectable answer elements (or other interactive elements), the timing of each interaction with the selectable elements, or a lack of interaction. The timing of the interactions may be measured in milliseconds from the beginning of the video secondary content presentation, from the beginning of the presentation of the selectable elements, and/or from the beginning of an opportunity to select another selectable element after the selection of an incorrect selectable answer element that resulted in a time-delay before the next interaction opportunity. Information 214 regarding the identified interaction (along with additional data received in information 204A or collected locally regarding the secondary content provided, the identifier for the content provided, a user ID, a browser ID, an application ID, etc.) may then be received at the secondary content provider (and more specifically at secondary content tracking server 270).

Secondary content tracking server 270 may then update records stored (e.g., locally or by a cloud provider) regarding campaigns, advertisements, users, questions, and interactions with interactive (answer) elements. In some aspect, the update is to the database entries created based on information 204B. The data may be stored as time-series data (e.g., data grouped or binned by associated times) that is aggregated and stored at different granularity based on a configuration of secondary content tracking server 270. In some aspects, the secondary content tracking server 270 performs an analysis of current stored feedback/interaction data (e.g., data for a last quarter, month, week, day, hour, etc.) to determine if any changes to secondary content selection parameters (or to secondary content elements) used by (accessed by) secondary content server 260 are triggered by the stored interaction data. For example, the secondary content tracking server 270 may determine that an average time for a correct selection of a selectable answer for a particular question has fallen below a threshold (e.g., 0.5 seconds) indicating that users are no longer engaging with the secondary content but have instead memorized the correct answer and are effectively using the correct answer as a skip button. Accordingly, secondary content tracking server 270 may send a request 216 to update information stored (or accessed) by secondary content server 260 (e.g., to remove a particular question or advertisement from the set of candidate questions or advertisements or to identify the advertisement or question as an element for which new questions or answers should be generated). The analysis may be performed by a feedback component (e.g., feedback component 172/872 of FIGS. 1 and 8). The analysis may occur periodically, or based on an event such as the reception of a particular number (e.g., 1, 100, 1000, etc.) instances of interaction information at the secondary content tracking server 270.

FIG. 3 is a diagram 300 illustrating an example of secondary content 350 provided to a client device 310 being composed 324 to overlay primary content layer 380. As used here, the terms compose or composition describe a process for combining visual data within a frame for display on an electronic device (e.g., client device 310). Composition may be based on the size and location of the visual material in each layer as well as a z-order indicating the relative position of the layers (which layers “cover” other layers when the layers overlap in the display area). The result of a composition process may be referred to here as a frame.

FIG. 3 illustrates secondary content server 360 (similar to secondary content servers 160 and 260 of FIGS. 1 and 2) providing secondary content information 350 to secondary content client 314 to display secondary content on top of primary content layer 380 being displayed by primary content player 312. Secondary content information 350, as illustrated here, may include a secondary content non-interactive video element identifier (e.g., URL) 352 (identifying non-interactive video secondary content layer 352a and a location from which to retrieve video secondary content to display within the layer 352a). Secondary content information 350 may also include secondary content non-interactive question element data 354 and secondary content interactive answer element data 356. The secondary content information 350 may be based on information stored at secondary content elements storage 364 and be selected by secondary content selection component 362 as will be discussed in further detail in relation to FIGS. 6 and 7.

Secondary content non-interactive question element data 354 may specify a layer 354a including secondary content question element at a particular position and size, along with the content of the question element, and a time at which to begin and end displaying the question element. Secondary content interactive answer element data 356 may specify a layer 356a or 356b including secondary content interactive answer elements 357a or 357b at a particular position and size, along with the content of the interactive answer elements 357a (e.g., answers A-D) or 357b (e.g., text input element) element, a time at which to begin and end displaying the question element, and information as to whether each of the interactive answer elements 357a are correct (and will result in skipping the secondary content video element) or incorrect (and will lead to (1) being asked to try again, or (2) a “cooldown” period in which no interaction is possible before being presented the interactive answer elements 357a again). Similarly, information regarding the correct input (or a set of acceptable inputs) for text input element 357b may be provided.

FIG. 3 also illustrates a composed frame 324 based on the layers 352a-356a and 380. The content of layer 352a is not illustrated but should be understood to represent the secondary content video element retrieved by the client device 310 (or secondary content client 314). As shown, primary content layer 380 is a “backmost” layer with layer 352a being “in front of” layer 380 and layers 354a and 356a being “in front of” layer 352a. The relative order of layers 354a and 356a is not clear from the illustration, as the display elements do not overlap.

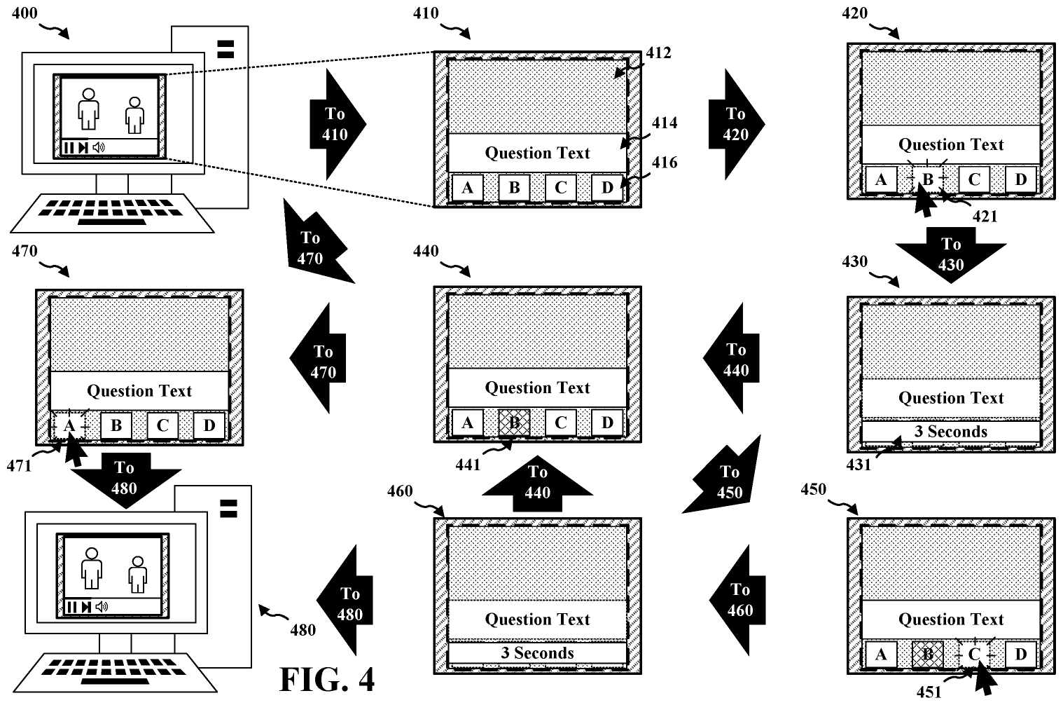

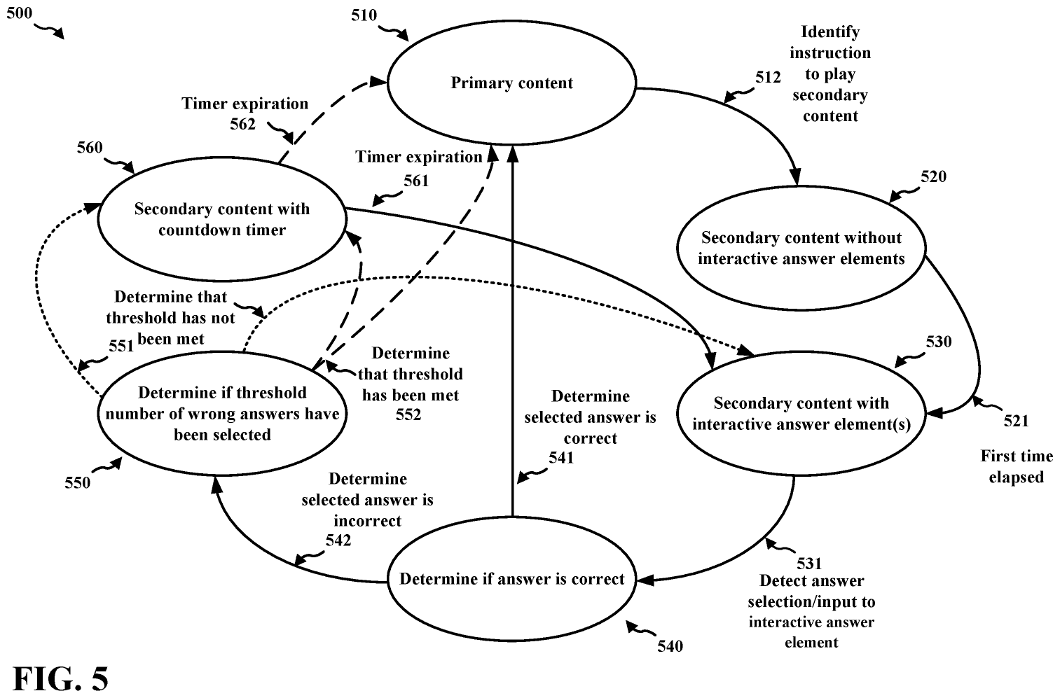

FIG. 4 is a diagram illustrating an example of a set of interactions (e.g., 421, 451, and 471) with secondary content interactive elements 416 that result in different actions being taken by a secondary content player (not shown) that result in displays 410-470. FIG. 5 is a state diagram 500 related to the transitions illustrated in FIG. 4. Accordingly, FIGS. 4 and 5 will be discussed in tandem. FIGS. 4 and 5 illustrate a first state 400 and 510, respectively, in which primary content is being displayed. At a particular time in the primary content a primary content player may identify 512 an instruction to play secondary content and initiate the processes described above in relation to FIGS. 1-3 to retrieve the secondary content and compose it for display. After the secondary content is composed, the player may transition to state 520 in which a secondary content player may display the secondary component video 412 element without interactive answer elements 416 (and without the question element 414).

After a first time 521 has elapsed (e.g., specified in secondary content interactive element data 356 of FIG. 3) the secondary content player may transition to state 530 corresponding to diagram 410, in which the secondary component video 412 element, the question element 414, and interactive answer elements 416 are all displayed. At 531 the client device (e.g., client device 110/210/310 or FIGS. 1-3) or the secondary content player detects an answer selection (e.g., 421, 451, or 471 as illustrated in corresponding diagrams 420, 450, and 470) or an input to, an interactive answer element and transitions to (transitory) state 540 to determine if the answer or input is correct (e.g., based on the received secondary content interactive answer element data 356 of FIG. 3). If the answer or input is determined 541 to be correct (as for answer selection 471 of diagram 470), the secondary content player may skip the rest of the secondary content (e.g., secondary content video element 412) and return to state 510 to play the primary content as illustrated in the transition from diagram 470 to diagram 480.

If the answer or input is determined 542 to be incorrect (as for answer selections 421 and 451 of diagrams 420 and 450), the secondary content player transitions to a state 550 to determine if a threshold number of wrong answers have been selected/input. If the secondary content player determines 552 that a threshold number of wrong answers (e.g., 2 wrong answers) has been received, the secondary content player may skip the rest of the secondary content (e.g., secondary content video element 412) and return to state 510 to play the primary content. Additionally, if the secondary content player determines 552 that a threshold number of wrong answers (e.g., 2 wrong answers) has been received, the secondary content player may transition to state 560 to display the “cooldown” timer before skipping the rest of the secondary content and transitioning, based on time expiration 562, to state 510 to play the primary content as illustrated in the transition from diagram 460 to diagram 480.

If the secondary content player determines 551 that a threshold number of wrong answers has not been received, the secondary content player may transition, if configured with a “cooldown” period, to state 560 in which a “cooldown” period timer 431 is displayed (corresponding to diagrams 430 and 460) before transitioning, based on timer expiration 561 to state 530 described above (corresponding to diagrams 410 and 440). Additionally, if the secondary content player determines 551 that a threshold number of wrong answers has not been received, the secondary content player may transition, if not configured with a “cooldown” period, to state 530 described above (corresponding to diagrams 410 and 440). In some aspects a previously selected selectable answer element 441 is not selectable after a first selection 421.

FIG. 6 is a diagram 600 illustrating an example of elements of a secondary content server 660. FIG. 7 is a diagram 700 illustrating example data entries 702-708 that may be stored by a secondary-content-server secondary content element data storage 764. As FIG. 7 is an example of data that may be stored in secondary content element data storage 664 of FIG. 6, FIGS. 6 and 7 will be discussed in tandem. FIG. 6 illustrates a secondary content server 660 (e.g., corresponding to server 160 of FIG. 1) that includes a secondary content selection component 662 that in some aspects selects (or identifies) secondary content to provide to an electronic device (e.g., client device 110/310 or electronic device 210 of FIGS. 1-3). Secondary content selection component 662 may include multiple components (e.g., hardware such as a network interface controller (NIC) or an application-specific integrated circuit (ASIC) or software components such as programs or sets of instructions), for performing different functions of secondary content selection component 662. The multiple different components, may be different functions or programs within a larger program and are presented as separate components for clarity.

In some aspects, secondary content server 660 may also include secondary content element data storage 664 storing data regarding different secondary content elements. Alternatively, or additionally, data regarding different secondary content elements may be stored on a storage area network (SAN) or in storage provided by a cloud provider accessed by secondary content server 660 (and particularly secondary content selection component 662). The data stored in secondary content element data storage 664 may include, in some aspects, secondary content campaign data 664a, advertisement data 664b, question data 664c, and answer data 664d. While the data is shown grouped as above, the data may be stored in a multi-dimensional database including all the data regarding the secondary content elements or a set of tables that each can be cross referenced with at least one other table to enable the data in one table to be identified as being related to data in another table. For example, in the illustrated data structures of FIG. 7, each of data entries 702-708 include an identifier that can be used to identify a relation between the entry 702-708 and any related entry 702-708 in a different data set 764a-d. The data from a first data structure 764a-d may be used to populate a different second data structure 764a-d as indicated by double ended arrows 710-714.

As illustrated, secondary content selection component 662 includes a secondary content client communication component 661; a secondary content campaign selection component 691; a secondary content video element selection component 693; a secondary content question element selection component 695; a secondary content answer element selection component 697; and a secondary content feedback processing component 669. Secondary content client communication component 661, may receive a request from an electronic device such as client device 110/310 or from a secondary content client 114/314 of FIGS. 1 and 3. The request may then be provided to a secondary content campaign selection component 691 of secondary content selection component 662.

Secondary content campaign selection component 691 may be configured to select a particular campaign from a set of campaigns stored in secondary content campaign data structure 664a. For example, secondary content campaign selection component 691 may select campaign C1 from the campaigns C1 to Cx stored in secondary content campaign data structure 764a of FIG. 7. As discussed in relation to FIG. 2, the secondary content client communication component 661 may receive, as part of the request information, a user ID (e.g., provided in metadata of the request) that may be used to identify characteristics of the user such as gender, age group, approximate income level, location, etc. that are used in identifying a campaign that is targeted to users having at least one characteristic of the user (e.g., age group, location, etc.). The set of criteria used to select a campaign may be input by a campaign manager through management client 144 of FIG. 1 which may also communicate with secondary content server 660. The factors may include non-user-specific data such as time of day, day of the week, etc. that may be relevant to a particular campaign. Additional parameters for the campaign selection and any of the selections discussed below may include statistical information provided by feedback component 172/872 of FIGS. 1 and 8, including a number of times a particular campaign, advertisement, question, or answer has been provided or the speed with which a particular question is answered correctly, or an average number of incorrect answers before a correct answer to a particular question.

As illustrated, secondary content selection component 662 further includes a secondary content video element selection component 693 configured to select a particular secondary content video element (e.g., an advertisement) from a set of candidate secondary content video elements. Secondary content video element selection component 693 may receive an identification of a selected campaign from secondary content campaign selection component 691. Based on the identified selected campaign, secondary content video element selection component 693 may select a particular secondary content video element (e.g., an advertisement) from a set of candidate secondary content video elements 664b. For example, based on the selection of campaign “C1,” secondary content video element selection component 693, may select advertisement A1 that is associated with C1 in secondary content campaign data structure 764a of FIG. 7. The selection of the advertisement by secondary content video element selection component 693 may also be based on the contextual data regarding the user and the non-user-specific data that may be relevant to the selection of a particular advertisement (e.g., advertisements starring an actress may be selected for a female between the ages of 18-35, while advertisements starring an NBA player may be selected for a male in the same age range). As discussed above, the set of criteria used to select an advertisement, a question, and a set of answers as discussed below may be input by a campaign manager through management client 144 of FIG. 1 which may also communicate with secondary content server 660.

Secondary content video element selection component 693 may then identify an entry in secondary content advertisement data 764b corresponding to advertisement A1 of campaign C1 (e.g., entry 704 for “C1:A1” of FIG. 7). The entry 704 of FIG. 7, may be used to identify a URL from a set of URLs from which to retrieve the selected secondary content video element to provide to a secondary content client (e.g., as secondary content non-interactive video element identifier 352 of FIG. 3). The entry 704 of FIG. 7, may also be used to identify a set of questions associated with the advertisement to be provided to secondary content question element selection component 695. Secondary content question element selection component 695 may be configured to receive the information regarding the selected secondary content video element (e.g., the advertisement identified in entry 704 of FIG. 7 as “C1:A1”) and select a particular question (or set of questions) associated with the advertisement. As above, the secondary content question element selection component 695 may receive an identification of an entry in the secondary content advertisement data 764b and select a secondary content question element from the questions associated with the advertisement in the identified entry (e.g., 704 of FIG. 7). Alternatively, secondary content question element selection component 695 may receive an identification of an advertisement and identify the related entry in secondary content advertisement data 764b. The secondary content question element selection component 695 may then select a secondary content question element from the set of candidate secondary content question elements.

For example, secondary content question element selection component 695 may select question “Qa” from the set of questions “Qa-Qd” associated with the selected advertisement C1:A1 in the entry 704 of secondary content advertisement data 764b of FIG. 7. The secondary content question element selection component 695 may then identify the secondary content question element content to be provided (e.g., as secondary content non-interactive question element data 354 of FIG. 3) based on an entry associated with the selected secondary content question element (e.g., entry 706 in secondary content question data 764c of FIG. 7). The secondary content question element selection component 695 may then identify the selected question to secondary content answer element selection component 697.

Secondary content answer element selection component 697 may be configured to receive the identification of a selected secondary content question element and select a set of secondary content answer elements associated with the selected secondary content question element. For example, based on the selection of the question identified as C1:A1:Qa, secondary content answer element selection component 697 may select a set of two or more answer elements from the set of answer elements “a1-a7”associated with question C1:A1:Qa in entry 706 of secondary content question data 764c of FIG. 7. The selection of the set of answer elements, in some aspects, includes (1) at least one correct answer, e.g., an answer that initiates a skip of the remainder of the secondary content video element and (2) at least one incorrect answer, e.g., an answer that begins a cooldown timer that disables answer selection during the cooldown period or that indicates that the answer was incorrect and allows a user to select another answer. The selection of the set of answer elements, in some aspects, includes the selection of a single text input answer element and a set of one or more correct inputs that that initiate a skip of the remainder of the secondary content video element. Any input received at the text input answer element other than an input in the set of one or more correct inputs may be considered incorrect and may begin a cooldown timer that disables answer input during the cooldown period or that indicates that the answer was incorrect and allows a user to input another answer. The content of a particular answer and the answer's status of correct/incorrect may be identified by secondary content answer element selection component 697 and may be provided along with the other selection information (e.g., secondary content non-interactive video element identifier 352, secondary content non-interactive question element data 354, and secondary content interactive answer element data 356 of FIG. 3) to secondary content client communication component 661 and ultimately to the requesting secondary content client 114/314 or client/electronic device 110/210/310 of FIGS. 1-3.

Secondary content selection component 662, in some aspects, also includes a secondary content feedback processing component that is configured to receive feedback from the secondary content tracking server 170/870 (and specifically, from feedback component 172/872) of FIGS. 1 and 8. The feedback may include information used to make selection decisions, such as a time to select a correct answer or a number of total selected answers for a particular question dropping below a threshold time or number, or a change to any other criteria used to select a campaign, a secondary content video element, question element, or answer element.

The secondary content server 660, in some aspects, includes means for receiving a request for secondary content to provide to the electronic device, based on a request by the electronic device for primary content. The secondary content server 660, in some aspects, may further include means for selecting secondary content to provide to the electronic device, the secondary content comprising a set of non-interactive elements and a set of one or more interactive elements, where the set on one or more interactive elements for receiving user interaction and responding with one of (1) skipping a remainder of a presentation of the selected secondary content and (2) indicating that the interaction will not cause the remainder of the presentation of the selected secondary content to be skipped. The secondary content server 660, in some aspects, may further include means for providing, to the electronic device, (1) data identifying the selected secondary data to the electronic device and (2) data regarding a first set of one or more interactions with the set of interactive elements that will trigger skipping the remainder of the presentation of the secondary content and a second set of one or more interactions with the set of interactive elements that will not trigger skipping the remainder of the presentation of the secondary content. The secondary content server 660, in some aspects, may further include means for selecting the non-interactive video advertisement from a plurality of candidate non-interactive video advertisements. The secondary content server 660, in some aspects, may further include means for selecting the non-interactive question overlay element from a plurality of candidate non-interactive question overlay elements associated with the selected non-interactive video advertisement. The secondary content server 660, in some aspects, may further include means for selecting the plurality of selectable answer elements from a set of candidate selectable answer elements associated with the selected non-interactive question overlay. The secondary content server 660, in some aspects, may further include means for receiving, from a different electronic device, information regarding a set of selectable answer elements of a plurality of selectable answer elements provided to the different electronic device based on a previous request for primary content from the different electronic device, the set of selectable answer elements comprising selectable answer elements selected at the different electronic device.

FIG. 8 is a diagram 800 illustrating an example of elements of a secondary content tracking server 870. FIG. 9 is a diagram 900 illustrating example data 976a-d that may be received and stored by a secondary content tracking server 976. As FIG. 9 is an example of data that may be stored in secondary content element data storage 876 of FIG. 8, FIGS. 8 and 9 will be discussed in tandem. FIG. 8 illustrates a secondary content tracking server 870 (e.g., corresponding to server 170 of FIG. 1) that include s a feedback component 872, analysis component 874, and secondary content data storage 876 (corresponding to feedback component 172, analysis component 174, and secondary content data storage 176 of FIG. 1). Secondary content tracking server 870 also includes data collection component 891 for receiving data from the secondary content client 114 (or client device 110) of FIG. 1.

FIG. 8 illustrates the feedback component 872 may include a secondary content server communication component 873; a secondary content video element analysis component 875; a secondary content question element analysis component 877; and a secondary content answer element analysis component 879. Feedback component 872 may receive current statistics or other data regarding secondary content video elements, question elements, and/or answer elements. For example, a database query component 883 may be configured to perform a particular database query periodically or based on an event detection and return the results to feedback component 872. Database query component 883 may be configured to perform different period or event-based queries (e.g., with different periodicities or triggering events) for data relating to secondary content video elements, question elements, and/or answer elements and to provide the query results to one of secondary content video element analysis component 875; secondary content question element analysis component 877; and/or secondary content answer element analysis component 879. Queries performed by database query component 883 may identify (and return) relevant data in secondary content data storage 876 and, specifically, in interactive selection data 876a, user data 876b, secondary content question data 876c, secondary content advertisement 876d.

The secondary content analysis component (e.g., one or more of analysis components 875-879) that receives the query results may perform a user-defined analysis or a pre-programmed analysis (e.g., a default analysis) to determine whether any update to criteria related to the selection of secondary content associated with the query results (e.g., secondary content video elements, question elements, and/or answer elements) is triggered. Any identified update triggered by the analysis is then provided to secondary content server communication component 873 to be provided to a secondary content server (e.g., 160/660 of FIGS. 1 and 6) or a particular secondary content selection component (e.g., secondary component selection components 691-697). The update may be (1) an update to a weight used in a weighted round robin selection operation/algorithm for selecting at least one of the candidate video elements, question elements, or answer elements, (2) an update to the candidate video elements, question elements, or answer elements such as an addition or removal of a candidate, or (3) some other update to the selection process of any of secondary component selection components 691-697 of FIG. 6.

As discussed above the analysis may determine that an average time for a correct selection of (or input to) an answer element for a particular question has fallen below a threshold (e.g., 0.5 seconds) indicating that users are no longer engaging with the secondary content but have instead memorized the correct answer and are effectively using the correct answer as a skip button. Such a determination may trigger the removal of the particular correct answer from the candidate secondary content answer elements for the question. If there is no correct answer remaining in the candidate secondary content answer elements, the determination may trigger the removal of the question from the set of candidate secondary content question elements. If no other candidate questions are associated with an advertisement, the determination may further trigger the removal of the advertisement from the candidate secondary content video elements. Removing a secondary content element from a set of candidates may be accomplished by setting an associated weight to “0.” By setting the weight to 0 instead of removing the secondary content element, the possibility of generating a new question element or answer element and updating the weight of the “removed” secondary content element to a non-zero value to effectively add it back to the set of candidate secondary content elements.

Secondary content tracking server 870 may further include analysis component 874 (corresponding to elements 174 of FIG. 1). Analysis component 874 include analytic s client interface 881; database query component 883; query result analysis component 885; and query result analysis presentation component 887. Analytics client interface 881 may be configured to receive requests for analytics (in a JavaScript Object Notation (JSON) format or in another format), parse received request and send the relevant data to database query component 883. Database query component 883 may be configured to generate a database query based on the data received from analytics client interface 881 or execute a database query received from analytics client interface 881.

Database query component 883 may be configured to receive the results of an executed query from the secondary content data storage (e.g., a local storage, a SAN, or a cloud storage), and provide the results to query result analysis component 885 to analyze the results according to user- or pre-programmed analysis algorithms or functions. The analysis may include computing averages (weighted averages, moving averages, trailing period averages, etc.) of characteristics (e.g., average number of answers to achieve a skip, average time to correct answer, etc.) programmed based on their relevance to an advertisement campaign manager using analytics client 142 of FIG. 1. The query result analysis component 885 may be configured to send the query results or the analysis to the query result analysis presentation component 887.

The query result analysis presentation component 887 may be configured to generate useful graphical representations of the query and analysis results and to provide the generated graphical representations to the analytics client interface 881. The analytics client interface 881 may further be configured to provide the generated graphical representations to the analytics client 142 of FIG. 1.

The data collection component 891, may receive data 920 from a secondary content client or client/electronic device (e.g., elements 114/314 and 110/210/310 of FIGS. 1-3). Referring to FIG. 9, the received data 920 may include any or all of an identifier 901 of a question element (including the associated campaign and advertisement/video element) provided in secondary content; a time 902 associated with the secondary content provided (measured as a UTC time); a set of provided answer identifiers 903; an ordered set of selected answers 904; an ordered set of times 905 before a selection of a corresponding selected answer in the ordered set of selected answers; a user ID 906; a browser ID 907; an application ID 908; settings 909 (e.g., a cooldown timer period setting, a maximum number of wrong answers before an automatic skip, etc.); and interaction ID 910 (an ID that can be associated with each database or table entry to correlate data in different databases or tables). Additional information may be collected as is appropriate for the situation.

The data collection component 891 may also be configured to parse the received (collected) data 920 for storage in the secondary content element data 876/976. For example elements 901-905 (and 910) may be parsed, identified as being relevant to interactive element selection data 976a (or 876a), and written to interactive element selection data 976a (or 876a); elements 906-909 may be parsed, identified as being relevant to user data 976b (or 876b), and written to user data 976b (or 876b); elements 901, 905 and 906 may be parsed and the data may be processed before updating an entry in one of secondary content question data 976c (or 876c) and/or secondary content question data 976d (or 876d).

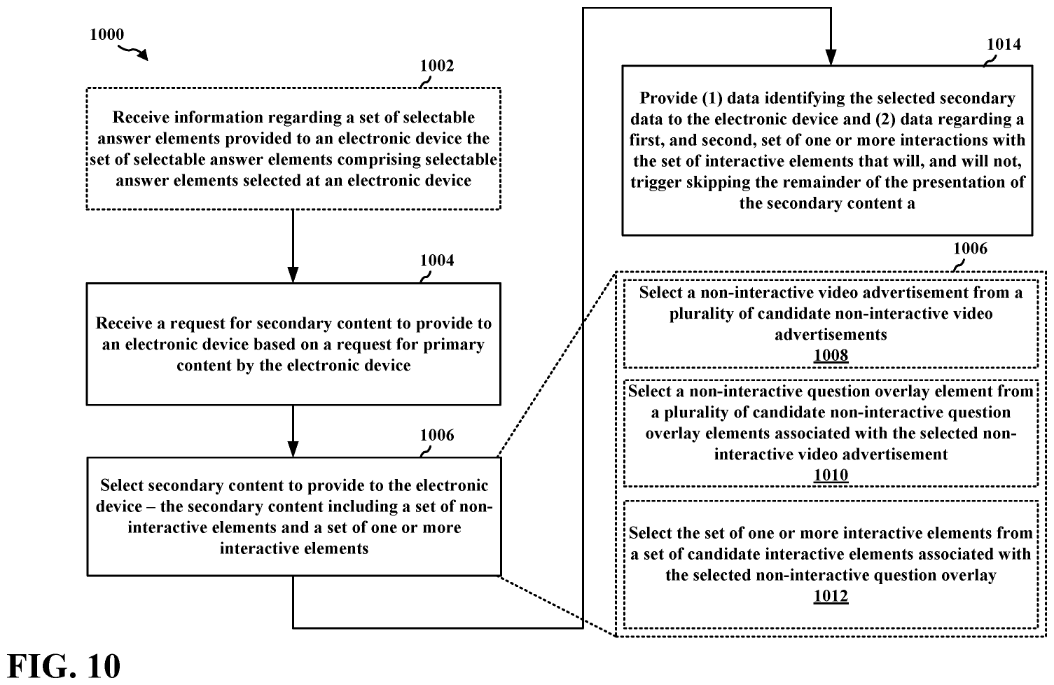

FIG. 10 is a flowchart 1000 of a method of providing secondary content. The method may be performed by a secondary content provider 150/250 of FIGS. 1 and 2 (e.g., by secondary content server 160, 260, 360, and/or 660 of FIGS. 1-3 and 6). The method may receive, at 1002, information regarding a set of selectable answer elements provided to an electronic device the set of selectable answer elements comprising selectable answer elements selected at an electronic device. For example, referring to FIGS. 1, 2, 4, 6, 8, and 9, a secondary content server 160/260/660 may receive from secondary content tracking server 170/270/870 information based on information 212/920 provided from an electronic/client device 110/210 or secondary content client 114 to the secondary content tracking server 170/270/870. The data may be received through secondary content feedback processing component 669. As discussed in relation to FIG. 9, the information may include information relating to any or all of an identifier 901 of a question element (including the associated campaign and advertisement/video element) provided in secondary content; a time 902 associated with the secondary content provided (measured as a UTC time); a set of provided answer identifiers 903; an ordered set of selected answers 904; an ordered set of times 905 before a selection of a corresponding selected answer in the ordered set of selected answers; a user ID 906; a browser ID 907; an application ID 908; settings 909 (e.g., a cooldown timer period setting, a maximum number of wrong answers before an automatic skip, etc.); and interaction ID 910 (an ID that can be associated with each database or table entry to correlate data in different databases or tables). Additional information may be collected and provided to a secondary content tracking server 170/870 as is appropriate for the situation.

At 1004, the secondary content provider 150/250 may receive a request for secondary content to provide to an electronic device. The request may be received from a secondary content client executing on the client device, a primary content player executing on the electronic device or some or other element of the system illustrated in diagram 100. The request may be received based on a request by the electronic device for primary content. For example, referring to FIGS. 1, 2, and 6, a secondary content server 160/260/660 may receive a request (e.g., request 202) for secondary content at secondary content client communication component 661 from an electronic/client device 110/210 or secondary content client 114.

The secondary content provider 150/250, at 1006, may select secondary content to provide to the electronic device. For example, referring to FIG. 6, the secondary content may be selected from secondary content element data storage 664 and more specifically, from campaign data 664a, advertisement data 664b, question data 664c, and answer data 664d. The secondary content may include a set of non-interactive elements and a set of one or more interactive elements. The set on one or more interactive elements may be interactive elements for receiving user interaction and responding with one of (1) skipping a remainder of a presentation of the selected secondary content and (2) indicating that the interaction will not cause the remainder of the presentation of the selected secondary content to be skipped. For example, referring to FIG. 3, secondary content server 360 may select a secondary content non-interactive video element identified by secondary content non-interactive video element identifier (e.g., URL) 352, secondary content non-interactive question element data 354, and secondary content interactive answer element data 356.

In some aspects, selecting secondary content to provide to the electronic device at 1006 may include: selecting a non-interactive video advertisement from a plurality of candidate non-interactive video advertisements at 1008; selecting a non-interactive question overlay element from a plurality of candidate non-interactive question overlay elements associated with the selected non-interactive video advertisement at 1010; and selecting the plurality of selectable answer elements from a set of candidate selectable answer elements associated with the selected non-interactive question overlay at 1012. For example, referring to FIGS. 6 and 7, the secondary content campaign selection component 691 may identify a plurality of candidate campaigns from secondary content campaign data structure 764a and select a particular campaign. The secondary content video element selection component 693 may select a non-interactive video advertisement from the plurality of candidate non-interactive video advertisements identified in entry 702 of secondary content campaign data structure 764a for a selected campaign. The selected secondary non-interactive video advertisement may then be used to identify a plurality of candidate non-interactive question overlay elements associated with the selected non-interactive video advertisement from entry 704 of secondary content advertisement data 764b. The secondary content question element selection component 695 may select a non-interactive question overlay element from the plurality of candidate non-interactive question overlay elements identified in entry 704 of secondary content advertisement data 764b. The selected non-interactive question overlay element may then be used to identify a plurality of candidate selectable answer elements associated with the selected non-interactive question overlay from entry 706 of secondary content question data 764c. The secondary content answer element selection component 697 may select a plurality of selectable answer elements from the set of candidate selectable answer elements associated with the selected non-interactive question overlay identified in entry 706 of secondary content question data 764c. The content associated with a particular selectable answer element in the selected plurality of selectable answer elements may be identified in entry 708 of secondary content answer data 764d.

Once the secondary content has been selected, the secondary content server may, at 1014, provide the electronic device (1) data identifying the selected secondary data to the electronic device and (2) data regarding a first set of one or more interactions with the set of interactive elements that will trigger skipping the remainder of the presentation of the secondary content and a second set of one or more interactions with the set of interactive elements that will not trigger skipping the remainder of the presentation of the secondary content. For example, referring to FIGS. 2 and 3 secondary content server 260/360 may supply information 204A regarding the set of selected secondary content elements of FIG. 2, or secondary content information 350 including secondary content non-interactive video element identifier 352, secondary content non-interactive question element data 354, and secondary content interactive answer element data 356 of FIG. 3.

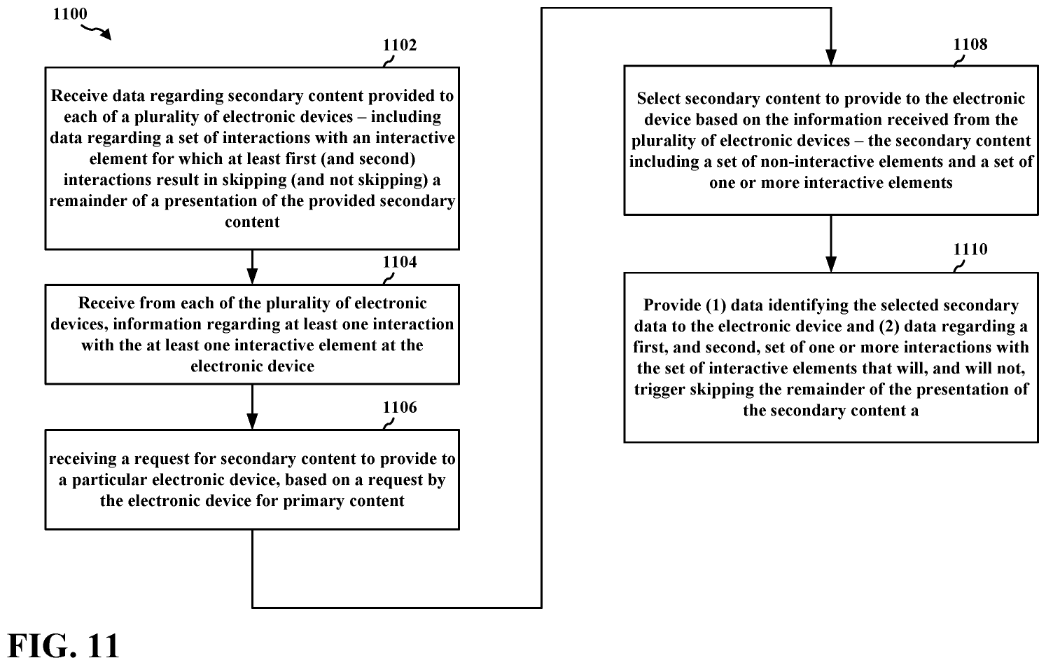

FIG. 11 is a flowchart 1100 of a method of tracking provided secondary content. The method may be performed by a secondary content provider (e.g., secondary content provider 150/250 of FIGS. 1 and 2). The method may receive, at 1102, data regarding secondary content provided to each of a plurality of electronic devices based on requests by the plurality of electronic devices for primary content. The secondary content provided to each of the plurality of electronic devices may include a set of non-interactive elements and a set of one or more interactive elements. The set of one or more interactive elements may be configured to receive a set of user interactions. The secondary content provided to each of the plurality of electronic devices may include an identification of at least one interaction resulting in skipping a remainder of a presentation of the provided secondary content and at least one interaction resulting in indicating that the interaction will not cause the remainder of the presentation of the identified secondary content to be skipped. For example, referring to FIGS. 8 and 9, a secondary content tracking server 870 of a secondary content provider (e.g., 150/250 of FIGS. 1 and 2) may receive data such as data 920 that identifies secondary content provided to an electronic device (e.g., an identifier 901 of a question element (including the associated campaign and advertisement/video element) provided in secondary content and a set of provided answer identifiers 903). The data may be received through a data collection component 891 from each of a plurality of electronic/client devices 110/210 or secondary content clients 114.

The secondary content tracking server of the secondary content provider may also receive, at 1104, information regarding a set of interactions at the electronic device with the set of one or more interactive elements provided to the electronic device. The information may be received at the secondary content tracking server from each of the plurality of electronic devices. For example, referring to FIGS. 8 and 9, a secondary content tracking server 870 of the secondary content provider may receive data such as data 920 that identifies a set of interactions at the electronic device with the set of one or more interactive elements provided to the electronic device (e.g., an ordered set of selected answers 904; an ordered set of times 905 before a selection of a corresponding selected answer in the ordered set of selected answers). The data may be received through a data collection component 891 from each of a plurality of electronic/client devices 110/210 or secondary content clients 114.

The secondary content provider may also receive, at 1106, a request for secondary content to provide to a particular electronic device. The request may be received from a secondary content client executing on the client device, a primary content player executing on the electronic device or some or other element of the system illustrated in diagram 100. The request may be received based on a request by the electronic device for primary content. For example, referring to FIGS. 1, 2, and 6, a secondary content server 160/260/660 may receive a request (e.g., request 202) for secondary content at secondary content client communication component 661 from an electronic/client device 110/210 or secondary content client 114.

The secondary content provider may select, a 1108, secondary content to provide to the particular electronic device based on the information received from the plurality of electronic devices regarding the set of interactions. The secondary content may include a set of non-interactive elements and a set of one or more interactive elements. The set of one or more interactive elements may be configured to receive user interaction and respond with one of (1) skipping a remainder of a presentation of the selected secondary content and (2) indicating that the interaction will not cause the remainder of the presentation of the selected secondary content to be skipped. For example, referring to FIG. 3, secondary content server 360 may select a secondary content non-interactive video element identified by secondary content non-interactive video element identifier (e.g., URL) 352, secondary content non-interactive question element data 354, and secondary content interactive answer element data 356. As discussed above in relation to FIG. 10, selecting secondary content to provide to the particular electronic device may include sub steps similar to sub steps 1008-1012 of FIG. 10.

Once the secondary content has been selected, the secondary content server may, at 1110, provide the electronic device (1) data identifying the selected secondary data to the electronic device and (2) data regarding a first set of one or more interactions with the set of interactive elements that will trigger skipping the remainder of the presentation of the secondary content and a second set of one or more interactions with the set of interactive elements that will not trigger skipping the remainder of the presentation of the secondary content. For example, referring to FIGS. 2 and 3 secondary content server 260/360 may supply information 204A regarding the set of selected secondary content elements of FIG. 2, or secondary content information 350 including secondary content non-interactive video element identifier 352, secondary content non-interactive question element data 354, and secondary content interactive answer element data 356 of FIG. 3.

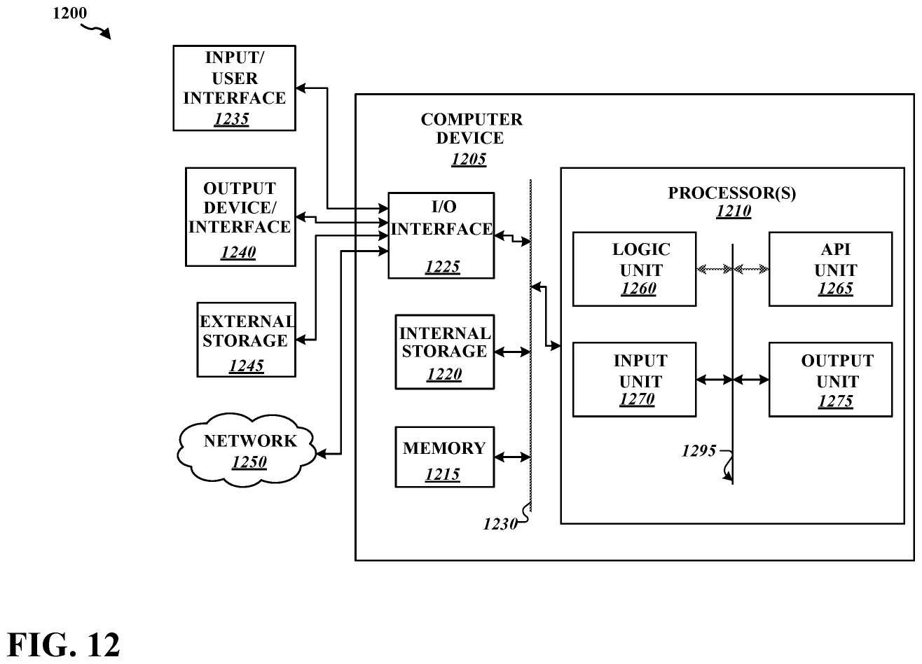

FIG. 12 illustrates an example computing environment in which the aspects discussed above can be implemented. Example implementations for the secondary content server and secondary content tracking server as illustrated in FIGS. 1, 3, and 6-9 along with the flow diagrams of FIGS. 10 and 11 can be executed on a computer device 1205 configured to be a secondary content server, or a computer device 1205 configured to be a secondary content tracking server. Computer device 1205 in computing environment 1200 can include one or more processing units, cores, or processors 1210, memory 1215 (e.g., RAM, ROM, and/or the like), internal storage 1220 (e.g., magnetic, optical, solid state storage, and/or organic), and/or I/O interface 1225, any of which can be coupled on a communication mechanism or bus 1230 for communicating information or embedded in the computer device 1205.

Computer device 1205 can be communicatively coupled to input/user interface 1235 and output device/interface 1240. Either one or both of input/user interface 1235 and output device/interface 1240 can be a wired or wireless interface and can be detachable. Input/user interface 1235 may include any device, component, sensor, or interface, physical or virtual, that can be used to provide input (e.g., buttons, touch-screen interface, keyboard, a pointing/cursor control, microphone, camera, braille, motion sensor, optical reader, and/or the like). Output device/interface 1240 may include a display, television, monitor, printer, speaker, braille, or the like. In some example implementations, input/user interface 1235 and output device/interface 1240 can be embedded with or physically coupled to the computer device 1205. In other example implementations, other computer devices may function as or provide the functions of input/user interface 1235 and output device/interface 1240 for a computer device 1205.

Examples of computer device 1205 may include, but are not limited to, highly mobile devices (e.g., smartphones, devices in vehicles and other machines, devices carried by humans and animals, and the like), mobile devices (e.g., tablets, notebooks, laptops, personal computers, portable televisions, radios, and the like), and devices not designed for mobility (e.g., desktop computers, other computers, information kiosks, televisions with one or more processors embedded therein and/or coupled thereto, radios, and the like).

Computer device 1205 can be communicatively coupled (e.g., via I/O interface 1225) to external storage 1245 and network 1250 for communicating with any number of networked components, devices, and systems, including one or more computer devices of the same or different configuration. Computer device 1205 or any connected computer device can be functioning as, providing services of, or referred to as a server, client, thin server, general machine, special-purpose machine, or another label.

I/O interface 1225 can include, but is not limited to, wired and/or wireless interfaces using any communication or I/O protocols or standards (e.g., Ethernet, 802.11x, Universal System Bus, WiMax, modem, a cellular network protocol, and the like) for communicating information to and/or from at least all the connected components, devices, and network in computing environment 1200. Network 1250 can be any network or combination of networks (e.g., the Internet, local area network, wide area network, a telephonic network, a cellular network, satellite network, and the like).

Computer device 1205 can use and/or communicate using computer-usable or computer-readable media, including transitory media and non-transitory media. Transitory media include transmission media (e.g., metal cables, fiber optics), signals, carrier waves, and the like. Non-transitory media include magnetic media (e.g., disks and tapes), optical media (e.g., CD ROM, digital video disks, Blu-ray disks), solid state media (e.g., RAM, ROM, flash memory, solid-state storage), and other non-volatile storage or memory.

Computer device 1205 can be used to implement techniques, methods, applications, processes, or computer-executable instructions in some example computing environments. Computer-executable instructions can be retrieved from transitory media, and stored on and retrieved from non-transitory media. The executable instructions can originate from one or more of any programming, scripting, and machine languages (e.g., C, C++, C #, Java, Visual Basic, Python, Perl, JavaScript, and others).

Processor(s) 1210 can execute under any operating system (OS) (not shown), in a native or virtual environment. One or more applications can be deployed that include logic unit 1260, application programming interface (API) unit 1265, input unit 1270, output unit 1275, and inter-unit communication mechanism 1295 for the different units to communicate with each other, with the OS, and with other applications (not shown). The described units and elements can be varied in design, function, configuration, or implementation and are not limited to the descriptions provided.

In some example implementations, when information or an execution instruction is received by API unit 1265, it may be communicated to one or more other units (e.g., logic unit 1260, input unit 1270, output unit 1275). In some instances, logic unit 1260 may be configured to control the information flow among the units and direct the services provided by API unit 1265, input unit 1270, output unit 1275, in some example implementations described above. For example, the flow of one or more processes or implementations may be controlled by logic unit 1260 alone or in conjunction with API unit 1265. The input unit 1270 may be configured to obtain input for the calculations described in the example implementations, and the output unit 1275 may be configured to provide output based on the calculations described in example implementations.

In some aspects, secondary content software executing on an electronic device provides secondary content on a secondary content player and permits network users the ability to skip secondary content such as advertising by correctly answering one or more questions relating to the ad, advertiser, or other reference related to the secondary content. The questions may take any suitable form such as fill in the blank, multiple choice, and/or yes/no. The question or questions may appear within the secondary content player. Answering the question correctly, in some aspects, is the method that initiates the content skip process. If the user answers the question or questions incorrectly, in some aspects, the secondary content continues to play, and the opportunity to answer the question(s) may again be offered after any suitable preset time period such as 0 to 10 seconds (e.g., 4 seconds). If answered incorrectly yet again, the process may repeat (e.g., until a threshold number of wrong answers is received). The rationale for such delay is to incentivize or train/teach and “reward” users for paying attention to the presented secondary content, and “penalize” them for not doing so. This process also produces data related to the user and the user's ability to correctly answer questions related to the secondary content.

When the computer device 1205 is configured to provide interactive secondary content from a secondary content provider to an electronic device, the processor(s) 1210 can be configured to receive a request for secondary content to provide to the electronic device, based on a request by the electronic device for primary content; select secondary content to provide to the electronic device, the secondary content comprising a set of non-interactive elements and a set of one or more interactive elements, the set on one or more interactive elements for receiving user interaction and responding with one of (1) skipping a remainder of a presentation of the selected secondary content and (2) indicating that the interaction will not cause the remainder of the presentation of the selected secondary content to be skipped; and provide, to the electronic device, (1) data identifying the selected secondary data to the electronic device and (2) data regarding a first set of one or more interactions with the set of interactive elements that will trigger skipping the remainder of the presentation of the secondary content and a second set of one or more interactions with the set of interactive elements that will not trigger skipping the remainder of the presentation of the secondary content as illustrated in FIGS. 3, 10, and 11. The processor(s) 1210 may be further configured to receive, from each of a plurality of electronic devices, information regarding a set of selectable answer elements of a plurality of selectable answer elements provided to the electronic device based on a previous request for primary content from the electronic device, where the set of selectable answer elements includes selectable answer elements selected at the electronic device as illustrated in FIGS. 8, 9, and 11.

When the computer device 1205 is configured to present interactive secondary content received from a secondary content provider to the computer 1205, the processor(s) 1210 can be configured to receive (1) data identifying the selected secondary data to the electronic device and (2) data regarding a first set of one or more interactions with the set of interactive elements that will trigger skipping the remainder of the presentation of the secondary content and a second set of one or more interactions with the set of interactive elements that will not trigger skipping the remainder of the presentation of the secondary content; display the secondary content identified in the received data including the set of one or more interactive elements; detect a first interaction with an interactive element in the set of one or more interactive elements; determine that the first interaction belongs to the second set of one or more interactions with the set of interactive elements that will not trigger skipping the remainder of the presentation of the secondary content; displaying an indication that the secondary content will not be skipped based on the first interaction; detect a second interaction with an interactive element in the set of one or more interactive elements; determine that the second interaction belongs to the first set of one or more interactions with the set of interactive elements that will trigger skipping the remainder of the presentation of the secondary content; and skip the remainder of the secondary content to allow primary content to be displayed as illustrated in FIGS. 4 and 5.

As described above, secondary content providers such as publishers, advertisers and their agencies may customize questions and answers for presentation to users using a secondary content server application (e.g., secondary content admin device 140 of FIG. 1). This capability may be provided in the server software. Secondary content providers may access the server application and the server software from any suitable device connected to the network 130 of FIG. 1. The secondary content providers can upload any suitable secondary content as well as customized questions and/or answers to appear within the secondary content player to a service server (e.g., secondary content server 160 of FIG. 1), as well as customized and/or answers questions (e.g., question 354a and answers 357a and 357b of FIG. 3) to appear within the content player provided by player/widget, software (e.g., secondary content client 114/314 of FIGS. 1 and 3). This interactive format facilitates interaction and engagement between a viewer and content such as a video advertisement.

The secondary content player software may be used as a delivery mechanism for any video advertisements such as pre-roll and mid-roll advertisements whereby a viewer or user may be shown any suitable secondary content such as an advertisement before (or during) the user's chosen primary content. Instead of a typical passive or ignored consumer ad experience, the secondary content player software prompts user input and engagement in the form of an advertiser sanctioned question, with several predefined multiple-choice answer options and benefits to the user for their inputs. In an aspect of secondary content player software, the user is “rewarded” by being able to skip an ad quickly by correctly answering the custom question through the content player.

The content player software captures the user responses as data (e.g., data 920 of FIG. 9) and transfers the data to the secondary content provider, the server software (e.g., software executing on secondary content tracking server 170/870 of FIGS. 1 and 8) compiles, stores, and provides the aggregated data to the advertisers such as an administrator of an advertisement campaign as part of its service. A provider of this service may offer its product/software for a fee, to publishers or direct advertisers, and/or their agencies. Another revenue option could be in billing advertisers, publishers, or agencies on a user interaction/engagement basis, or a combination of the two.

In some aspects, users are able to sign up as uniquely identifiable users with a user ID (e.g., user ID 906 of FIG. 9) and a password which allows them to accumulate points or any other suitable tokens for correct answers on the content player participating websites to be used towards prizes, coupons, gift cards etc. Users are able to accumulate tokens or points across any web page that utilizes this variation of the content player software. Users may also create questions and answers for secondary content providers and receive points for questions and or answers that are used by a secondary content provider.

Alternatively, or additionally, in some aspects a content player secondary software extension is used which may not require authorization from primary content publishers. The software extension may continuously reward users for secondary content viewed such as advertising they watch around the network, irrespective of what network property the content was running on. The secondary software extension identifies the advertiser being displayed in any playing video ad, secondary content, and independently expands to ask a custom question related to the video ad, providing an additional layer and interaction with the video ad being displayed. Users are rewarded with any suitable token such as points, redeemable for coupons or other prizes, when they correctly answer the advertiser related question. The secondary software extension may be incorporated in any suitable software component such as a browser or other suitable vehicle.

Since the ad player, e.g., secondary content player, is not always visible a browser extension, and corresponding website, may be offered to allow users to check their current status of points and rewards at any point in time.

Every secondary content publisher using the secondary content player software, in some aspects, may get a JavaScript or other suitable file that may be inserted into the website code where the secondary content will reside. A secondary content publisher script file may contain basic parameters that are customized for every secondary content publisher such as: a partner ID and/or a HyperText Markup Language (HTML) Tag ID for the main content player.

The script will insert an HTML section depending on the events of the main content player, such as: a video starting, a video ending, a video reaching a certain point in time, a position and size for presenting questions and possible answers.

Within secondary content provider 150, secondary content server 160 may be a Representational State Transfer (REST) server that gets requests from a secondary content publisher's client running on a client server, and sends the appropriate responses in JSON format.

Upon initialization the secondary content publisher client may send data from the secondary content publisher script file such as the partner ID to the secondary content provider and the secondary content provider may send back the appropriate secondary content such as a video ad (a link), question ID, and one or more questions with available answers including at least one correct answer and one incorrect answer.

In some aspects, secondary content software compares the user's answer to the presented question with the correct answer and, if they are the same, initiates the secondary content skip process and sends data to secondary content provider (or secondary content tracking server). If the user's answer does not match the correct answer the secondary content software will continue presenting the secondary content until at least on question is correctly the user, at which point the secondary content software sends data to secondary content provider (or secondary content tracking server). In some aspects, when a user selects an answer, the secondary content publisher client may send the answer to the secondary content provider to check if the user's provided answer is correct. Secondary content provider then sends the appropriate response back to the secondary content publisher client. The secondary content publisher client may also provide feedback data regarding the interaction. The feedback data that may be sent to the secondary content provider in addition to the selected answer in this step may include: a question ID (e.g., information 901 of FIG. 9), browser info (e.g., browser ID 907 of FIG. 9), IP Address, Local time, UTC time (e.g., 902 of FIG. 9), how much time it took to answer once the options were shown (e.g., information 905 of FIG. 9).

When the secondary content provider receives the user data it also updates the secondary content database (e.g., secondary content element data storage 976 of FIG. 9) with the appropriate increments and may compile user data into an analytic s database as aggregated data. The details of the compilation and aggregation may be determined by an administrator and may depend on how data is going to be processed later.

It is understood that the specific order or hierarchy of blocks in the processes/flowcharts disclosed is an illustration of example approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not meant to be limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.” Terms such as “if,” “when,” and “while” should be interpreted to mean “under the condition that” rather than imply an immediate temporal relationship or reaction. That is, these phrases, e.g., “when,” do not imply an immediate action in response to or during the occurrence of an action, but simply imply that if a condition is met then an action will occur, but without requiring a specific or immediate time constraint for the action to occur. The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

The following aspects are illustrative only and may be combined with other aspects or teachings described herein, without limitation.

Aspect 1 is a method of providing interactive secondary content from a secondary content provider to an electronic device, the method including receiving a request for secondary content to provide to the electronic device, based on a request by the electronic device for primary content; selecting secondary content to provide to the electronic device, the secondary content comprising a set of non-interactive elements and a set of one or more interactive elements, the set on one or more interactive elements for receiving user interaction and responding with one of (1) skipping a remainder of a presentation of the selected secondary content and (2) indicating that the interaction will not cause the remainder of the presentation of the selected secondary content to be skipped; and providing, to the electronic device, (1) data identifying the selected secondary data to the electronic device and (2) data regarding a first set of one or more interactions with the set of interactive elements that will trigger skipping the remainder of the presentation of the secondary content and a second set of one or more interactions with the set of interactive elements that will not trigger skipping the remainder of the presentation of the secondary content.

Aspect 2 is the method of aspect 1, where the set of non-interactive elements of the secondary content comprises a non-interactive question overlay element for display at the electronic device and the set of interactive elements comprises a plurality of selectable answer elements for display at the electronic device, each selectable answer element including a possible answer to the non-interactive question overlay element for display.

Aspect 3 is the method of aspect 2, where the first set of one or more interactions with the set of interactive elements comprises a selection of any of a set of one or more selectable answer elements that is identified as including a correct answer to the non-interactive question overlay element; and the second set of one or more interactions with the set of interactive elements comprises a selection of any of a set of one or more selectable answer elements that is identified as including an incorrect answer to the non-interactive question overlay element.

Aspect 4 is the method of aspect 3, where the first set of one or more interactions with the set of interactive elements comprises a selection of a threshold number of selectable answer elements that are each identified as including an incorrect answer to the non-interactive question overlay element.

Aspect 5 is the method of any of aspects 2 or 3, where the selected set of non-interactive elements further comprises a non-interactive secondary content video element, a correct answer to the non-interactive question overlay element for display at the electronic device being included in the non-interactive secondary content video element.

Aspect 6 is the method of aspect 5, where the non-interactive secondary content video element comprises a non-interactive video advertisement.

Aspect 7 is the method of aspect 6, where selecting the secondary content include s selecting the non-interactive video advertisement from a plurality of candidate non-interactive video advertisements; selecting the non-interactive question overlay element from a plurality of candidate non-interactive question overlay elements associated with the selected non-interactive video advertisement; and selecting the plurality of selectable answer elements from a set of candidate selectable answer elements associated with the selected non-interactive question overlay.

Aspect 8 is the method of any of aspects 6 or 7, where at least the plurality of selectable answer elements is not displayed until the non-interactive video advertisement has been playing for at least a threshold amount of time.

Aspect 9 is the method of any of aspects 2, 3, or 5, including receiving, from a different electronic device, information regarding a set of selectable answer elements of a plurality of selectable answer elements provided to the different electronic device based on a previous request for primary content from the different electronic device, the set of selectable answer elements comprising selectable answer elements selected at the different electronic device, where selecting the particular secondary content to provide to the electronic device comprises selecting the plurality of selectable answer elements for display at the electronic device based on the information received from the different electronic device, and where the plurality of selectable answer elements provided to the different electronic device include selectable answer elements associated with the selected non-interactive question overlay element for display at the electronic device.

Aspect 10 is the method of aspect 1, where the set of non-interactive elements of the secondary content comprises a non-interactive question overlay element for display at the electronic device and the set of interactive elements comprises a text input element for display at the electronic device, the interactions with the text input element comprising submission of a user-provided answer to a question included in the non-interactive question overlay element.

Aspect 11 is the method of aspect 10, where the data regarding the first set of one or more interactions with the set of interactive elements comprises a submission of any of a set of one or more correct answers that will trigger skipping the remainder of the presentation of the secondary content, and the data regarding the second set of one or more interactions with the set of interactive elements comprises a submission of any answer that is not in the set of one or more correct answers that will trigger skipping the remainder of the presentation of the secondary content.

Aspect 12 is the method of any of aspects 1-11, where indicating that the interaction will not cause the remainder of the presentation of the identified secondary content to be skipped comprises presenting (1) an indication that interaction with the set of interactive elements is temporarily disabled and (2) a timer element indicating an amount of time until interaction with the set of interactive elements will be enabled.

Aspect 13 is an apparatus for serving secondary content including at least one processor coupled to a memory and configured to implement a method as in any of aspects 1 to 12.

Aspect 14 is a non-transitory computer-readable medium storing computer executable code, where the code when executed by a processor causes the processor to implement a method as in any of aspects 1 to 12.

What is claimed is:

1. A method of providing interactive secondary content from a secondary content provider to an electronic device, the method comprising:
receiving a request for secondary content to provide to the electronic device, based on a request by the electronic device for primary content;
selecting secondary content to provide to the electronic device, the secondary content comprising a set of non-interactive elements and a set of one or more interactive elements, the set on one or more interactive elements for receiving user interaction and responding with one of (1) skipping a remainder of a presentation of the selected secondary content and (2) indicating that the interaction will not cause the remainder of the presentation of the selected secondary content to be skipped; and
providing, to the electronic device, (1) data identifying the selected secondary data to the electronic device and (2) data regarding a first set of one or more interactions with the set of interactive elements that will trigger skipping the remainder of the presentation of the secondary content and a second set of one or more interactions with the set of interactive elements that will not trigger skipping the remainder of the presentation of the secondary content.

2. The method of claim 1, wherein the set of non-interactive elements of the secondary content comprises a non-interactive question overlay element for display at the electronic device and the set of interactive elements comprises a plurality of selectable answer elements for display at the electronic device, each selectable answer element including a possible answer to the non-interactive question overlay element for display.

3. The method of claim 2, wherein:
the first set of one or more interactions with the set of interactive elements comprises a selection of any of a set of one or more selectable answer elements that is identified as including a correct answer to the non-interactive question overlay element; and
the second set of one or more interactions with the set of interactive elements comprises a selection of any of a set of one or more selectable answer elements that is identified as including an incorrect answer to the non-interactive question overlay element.

4. The method of claim 3, wherein the first set of one or more interactions with the set of interactive elements comprises a selection of a threshold number of selectable answer elements that are each identified as including an incorrect answer to the non-interactive question overlay element.

5. The method of claim 2, wherein the selected set of non-interactive elements further comprises a non-interactive secondary content video element, a correct answer to the non-interactive question overlay element for display at the electronic device being included in the non-interactive secondary content video element.

6. The method of claim 5, wherein the non-interactive secondary content video element comprises a non-interactive video advertisement.

7. The method of claim 6, wherein selecting the secondary content comprises:
selecting the non-interactive video advertisement from a plurality of candidate non-interactive video advertisements;
selecting the non-interactive question overlay element from a plurality of candidate non-interactive question overlay elements associated with the selected non-interactive video advertisement; and
selecting the plurality of selectable answer elements from a set of candidate selectable answer elements associated with the selected non-interactive question overlay.

8. The method of claim 6, wherein at least the plurality of selectable answer elements is not displayed until the non-interactive video advertisement has been playing for at least a threshold amount of time.

9. The method of claim 2, further comprising:
receiving, from a different electronic device, information regarding a set of selectable answer elements of a plurality of selectable answer elements provided to the different electronic device based on a previous request for primary content from the different electronic device, the set of selectable answer elements comprising selectable answer elements selected at the different electronic device,
wherein selecting the secondary content to provide to the electronic device comprises selecting the plurality of selectable answer elements for display at the electronic device based on the information received from the different electronic device, and
wherein the plurality of selectable answer elements provided to the different electronic device include selectable answer elements associated with the selected non-interactive question overlay element for display at the electronic device.

10. The method of claim 1, wherein the set of non-interactive elements of the secondary content comprises a non-interactive question overlay element for display at the electronic device and the set of interactive elements comprises a text input element for display at the electronic device, the interactions with the text input element comprising submission of a user-provided answer to a question included in the non-interactive question overlay element.

11. The method of claim 10, wherein:
the data regarding the first set of one or more interactions with the set of interactive elements comprises a submission of any of a set of one or more correct answers that will trigger skipping the remainder of the presentation of the secondary content; and
the data regarding the second set of one or more interactions with the set of interactive elements comprises a submission of any answer that is not in the set of one or more correct answers that will trigger skipping the remainder of the presentation of the secondary content.

12. The method of claim 1, wherein indicating that the interaction will not cause the remainder of the presentation of the identified secondary content to be skipped comprise s presenting (1) an indication that interaction with the set of interactive elements is temporarily disabled and (2) a timer element indicating an amount of time until interaction with the set of interactive elements will be enabled.

13. A non-transitory computer-readable medium storing computer executable code, the code when executed by a processor causes the processor to:
receive a request for secondary content to provide to an electronic device, based on a request by the electronic device for primary content;
select secondary content to provide to the electronic device, the secondary content comprising a set of non-interactive elements and a set of one or more interactive elements, the set on one or more interactive elements for receiving user interaction and responding with one of (1) skipping a remainder of a presentation of the selected secondary content and (2) indicating that the interaction will not cause the remainder of the presentation of the selected secondary content to be skipped; and
provide, to the electronic device, (1) data identifying the selected secondary data to the electronic device and (2) data regarding a first set of one or more interactions with the set of interactive elements that will trigger skipping the remainder of the presentation of the secondary content and a second set of one or more interactions with the set of interactive elements that will not trigger skipping the remainder of the presentation of the secondary content.

14. The non-transitory computer-readable medium of claim 13, wherein the set of non-interactive elements of the secondary content comprises a non-interactive question overlay element for display at the electronic device and the set of interactive elements comprises a plurality of selectable answer elements for display at the electronic device, each selectable answer element including a possible answer to the non-interactive question overlay element for display.

15. The non-transitory computer-readable medium of claim 14, wherein:
the first set of one or more interactions with the set of interactive elements comprises a selection of any of a set of one or more selectable answer elements that is identified as including a correct answer to the non-interactive question overlay element; and
the second set of one or more interactions with the set of interactive elements comprises a selection of any of a set of one or more selectable answer elements that is identified as including an incorrect answer to the non-interactive question overlay element.

16. The non-transitory computer-readable medium of claim 14, wherein the code that when executed causes the processor to select the secondary content comprises code that when executed causes the processor to:
select non-interactive video advertisement from a plurality of candidate non-interactive video advertisements;
select the non-interactive question overlay element from a plurality of candidate non-interactive question overlay elements associated with the selected non-interactive video advertisement; and
select the plurality of selectable answer elements from a set of candidate selectable answer elements associated with the selected non-interactive question overlay.

17. The non-transitory computer-readable medium of claim 14, wherein the code that when executed causes the processor to select the secondary content comprises code that when executed causes the processor to:
receive, from a different electronic device, information regarding a set of selectable answer elements of a plurality of selectable answer elements provided to the different electronic device based on a previous request for primary content from the different electronic device, the set of selectable answer elements comprising selectable answer elements selected at the different electronic device,
wherein the code that when executed causes the processor to select the secondary content to provide to the electronic device comprises code that when executed causes the processor to select the plurality of selectable answer elements for display at the electronic device based on the information received from the different electronic device, and
wherein the plurality of selectable answer elements provided to the different electronic device associated with the selected non-interactive question overlay element for display at the electronic device.

18. The non-transitory computer-readable medium of claim 13, wherein the set of non-interactive elements of the secondary content comprises a non-interactive question overlay element for display at the electronic device and the set of interactive elements comprises a text input element for display at the electronic device, the interactions with the text input element comprising submission of a user-provided answer to a question included in the non-interactive question overlay element.

19. The non-transitory computer-readable medium of claim 18, wherein:
the data regarding the first set of one or more interactions with the set of interactive elements comprises a submission of any of a set of one or more correct answers that will trigger skipping the remainder of the presentation of the secondary content; and
the data regarding the second set of one or more interactions with the set of interactive elements comprises a submission of any answer that is not in the set of one or more correct answers that will trigger skipping the remainder of the presentation of the secondary content.

20. The non-transitory computer-readable medium of claim 13, wherein indicating that the interaction will not cause the remainder of the presentation of the identified secondary content to be skipped comprises presenting (1) an indication that interaction with the set of interactive elements is temporarily disabled and (2) a timer element indicating an amount of time until interaction with the set of interactive elements will be enabled.
